(19) United States
(12) Patent Application Publication
(10) Pub. No.: US 2017/0234903 A1
(43) Pub. Date: Aug. 17, 2017

(54) METHOD FOR IDENTIFYING A SENSOR APPARATUS FOR MEASURING SPEED, SENSOR APPARATUS FOR MEASURING SPEED, AND VEHICLE HAVING AT LEAST ONE SENSOR APPARATUS FOR MEASURING SPEED

(71) Applicant: WABCO GmbH, Hannover (DE)

(72) Inventors: Dirk BORMANN, Algermissen (DE); Jens GRÖGER, Hannover (DE); Marco GROSSE WORTMANN, Wagenfeld/Ströhen (DE); Sebastian KOSS, Hannover (DE); Stefan NIEBER, Garbsen (DE)

(21) Appl. No.: 15/519,211

(22) PCT Filed: Oct. 9, 2015
(86) PCT No.: PCT/EP2015/001996

§ 371 Date: Apr. 14, 2017

(30) Foreign Application Priority Data
Oct. 14, 2014 (DE) 10 2014 015 129.8

(51) Int. Cl. G01P 1/07; G01V 15/00; G01P 3/44

(52) U.S. Cl. CPC G01P 1/07; G01P 3/44; G01V 15/00

(57) ABSTRACT

A sensor device (12) to measure the speed of a wheel of a vehicle is disclosed. The sensor device (12) is assigned an identifier (28, 30, 32) which can be contactlessly read. The identifier (28, 30, 32) can be read by radio. A method for identifying the sensor device (12) and a vehicle including the sensor device (12) are also disclosed.

### CROSS-REFERENCE TO RELATED APPLICATIONS

This application is the National Stage of International Application No. PCT/EP2015/001996, filed on 9 Oct. 2015, which claims priority to and all advantages of German Patent Application No. 10 2014 015 129.8, filed on 14 Oct. 2014, the content of which is hereby incorporated by reference.

### FIELD OF THE INVENTION

The invention generally relates to a sensor device and, more specifically, to a sensor device for measuring the speed of a wheel of a vehicle. The invention also relates to a method for identifying the sensor device and to a vehicle comprising the sensor device.

### BACKGROUND OF THE INVENTION

Sensor devices can be used for determining the speed of a component of a vehicle. In particular, such devices are used in the field of measuring speed at wheels. Such devices are therefore referred to as wheel speed sensors. Different measuring principles are used, for example, optical, electrical or inductive methods.

A determination of the speed of a single wheel in the drive mode of the associated vehicle usually takes place in a continuous manner. This is important, in particular, for a stabilization of the drive mode or for braking operations. For example, electronic stabilization systems as well as anti-lock braking systems and similar systems are dependent on measured values of the individual wheel speeds. Thus, there are high requirements with respect to reliability and accuracy of sensor devices.

In order to be able to ensure an unambiguous identification of the sensor devices both during the process of producing a vehicle and in subsequent operation, a unique identifier is assigned to each sensor device for identification, i.e., so-called identification means. For this purpose, corresponding numerical codes, bar bodes, or matrix codes are applied onto the sensor devices or the housing thereof. This can take place, for example, by printing, by laser inscription, or in a similar way.

The readout can take place, for example, by a person or by suitable reading devices, such as code scanners. The term “reader” can incorporate both the person who is doing the reading as well as corresponding reading devices. Thus, the usual features used for identification are read in optical ways. This optical identification requires a direct line-of sight-link.

The disadvantage of the known method for identifying sensor devices is that, on the one hand, a line-of-sight link must exist between the sensor device and the assigned reader and, on the other hand, soiling, abraded material and the like can reduce the readability of the identification means, even rendering them unrecognizable.

The problem addressed by the present invention is therefore that of providing a method for identifying sensor devices and of providing a corresponding sensor device, in the case of which the disadvantages of the prior art are eliminated.

### SUMMARY OF THE INVENTION

The present invention provides a sensor device including an identifier. The identifier is read out by radio. This is a wireless transmission, in particular. For this purpose, assigned to this identifier is the sensor device for measuring the speed of a wheel of a vehicle. A readout by radio is contactless, in particular. One advantage of a readout by radio is that, specifically, there is no need for a line-of-sight link between the identifier and the reader or the reading device. Therefore, it is possible, in particular, to read out the identifier in tight spatial conditions and without a direct line-of-sight link. Superficial changes on the sensor device, which usually make it difficult or impossible to read out the usual identifier, are usually not a problem for the present identifier which can be read out by radio.

In certain embodiments, the identifier transmits an electrical and/or magnetic signal for identification. A corresponding signal, which can be used for identifying the sensor device, can therefore be received by the corresponding reader or reading device. The transmission by radio ensures that the sensor device can be identified via the identifier.

In specific embodiments, data are transmitted via the signal. The data transmitted via the signal are, in particular, identification data such as, for example, an identification number or an identification code. For this purpose, identification data are transmitted, such as at least one number or a code, in particular a numeric and/or alphanumeric code. In this way, an identification of the sensor device to which the identifier is assigned, is possible.

In various embodiments, at least one transponder or an electronic transponder is provided as the identifier. Typically, the transponder or electronic transponder is an RFID transponder (radio frequency identification device transponder). Such a transponder is an electronic unit for wireless readout. An RFID transponder is read out by radio. Data can be transmitted, which can be used, in particular, for identifying the RFID transponder and, therefore, an assigned device. RFID transponders for different purposes are known, for example, for use as theft-warning systems in department stores. In this case, such systems usually do not allow for a specific identification, but rather merely make it possible to determine the presence of an RFID transponder in an area. An RFID transponder as an identifier can typically be read out via electromagnetic radiation, in particular wirelessly.

In certain embodiments, the identifier contains at least one microchip as an active element. This microchip typically makes the identification possible by transmitting identification data by radio. Further still, in these or other embodiments, the microchip can perform further tasks in addition to identification, such as, in particular, storing and/or transmitting measurement data. These measurement data can be measurement data from the assigned sensor device or the like, in particular speed data or the like. For this purpose, these data are transmitted to the identifier. This can take place by way of a wired or wireless connection such as, for example, an electrical coupling, a radio connection or the like, between a pickup of the sensor device and the identifier.

In these or other embodiments, the identifier is supplied with energy from an external source. This means that the energy for operating the identifier is supplied from the outside. The supply typically takes place wirelessly, for example by radio. This is electrical energy, in particular, which is received via an antenna. This energy is used for operating the identifier. For this purpose, in certain embodiments a radio signal is transmitted in and is temporarily stored via an electrical energy accumulator of the identifier, for example, a capacitor or a rechargeable battery. This temporarily stored energy is used for operating the identifier, i.e., in particular for generating a signal for identification and for transmitting the signal by radio. Identification data or the like can therefore be transmitted.

In certain embodiments, the signal, in particular the radio signal of the identifier, is coupled into an on-board electrical system of the associated vehicle. For this purpose, the identifier can be situated, for example, in close proximity to at least one electrical line or an antenna of the on-board electrical system. In this case, an electromagnetic coupling results in at least one portion of the signal from the identifier being coupled into the electrical line or the antenna. This signal can then be called up in the electrical lines of the on-board electrical system. The identifier can be read out by the on-board electronics system. Given that the on-board electronics system evaluates the electrical, coupled-in signal or a signal transmitted from the identifier by radio, via data line or the like, the data contained in the signal can be further processed. The purpose thereof can be, for example, that the on-board electronics system checks for the presence of all sensor devices that are provided. In addition, the installation of at least one sensor device can be checked to ensure it is correct. For example, a correct orientation or positioning of the sensor device can be a precondition for achieving a certain extent of coupling into the on-board electrical system. A correct positioning or correct installation of the sensor device can therefore be ensured, for example.

The sensor device can be, in particular, a so-called wheel speed sensor. This sensor is usually used for determining the speed of a wheel, for example, via an inductive or optical measuring method, or via any other suitable measuring method. The sensor device is also usually an identifier which can be contactlessly read out. The sensor device is characterized, according to the invention, in that the identifier can be read out by radio. This offers the advantage over the solutions known from the prior art that a direct line-of-sight connection is not required. A readout by radio therefore also makes a use in tight spatial conditions possible. For example, a removal of the particular sensor device for the purpose of identifying the device can therefore usually be avoided. In addition, superficial soiling or damage to the identifier of the sensor device according to the invention usually do not make a difference.

In certain embodiments, the identifier is designed as a transponder, such as an electronic transponder. In a specific embodiment, an RFID transponder (radio frequency identification device transponder) is provided as the identifier. The latter is an electronic circuit which transmits at least one signal, one identification code or the like, by radio. For this purpose, the identifier typically comprises at least one microchip and at least one antenna. Identification is therefore made possible.

In various embodiments, the identifier is designed for storing and/or transmitting data for the purpose of identification. In simple variants such as, for example, for the detection of thieves in department stores, corresponding RFID transponders are designed merely for detecting their presence in a measuring range. In the present case, however, data are transmitted, which allow for an unambiguous identification of a certain sensor device. For this purpose, for example, identification codes or the like are transmitted, for example in the form of a character string. The identifier can store and/or transmit measurement data, in particular. Such measurement data can be, for example, speed data which can originate from the assigned sensor device. For this purpose, a corresponding transmission of the data from the sensor device to the identifier must be ensured. This can take place, for example, by radio, via electrical data line, or in a similar manner. In particular, the transmission or the storage of measurement data can take place in addition to the identification data. It is therefore ensured that a link between identification data, on the one hand, and measurement data, on the other hand, can be established. Therefore, specific connections can be established between a measured value and corresponding measurement transmitters. For example, a speed value can be assigned to a specific sensor.

The identifier usually does not have a separate power supply. The identifier can therefore be supplied with electrical energy, in particular, from the outside or from an external source. For this purpose, electrical energy may be transmitted by radio and be received by the identifier via an antenna. For this purpose, the identifier comprises a buffer storage for electrical energy, for example a capacitor or a battery. This energy can be used for operating the identifier or its microchip. The radio signal is therefore generated and transmitted.

In certain embodiments, a housing is assigned to the sensor device. The housing is used, in particular, for protecting the components of the sensor device and the identifier or for fastening to a vehicle. In addition, a plug-in connection is typically provided, which is used for connecting the sensor device to the on-board electrical system of the vehicle via a cable. The identifier can be assigned to the housing and to the plug-in connection and to the cable. The identifier can be connected to each of these components, for example, by bonding or by being inserted into an opening or recess. It is also possible for only one part of the identifier, such as, in particular, a microchip or the like, to be situated in the interior of the housing or, for example, in a recess therein. The identifier is protected against damage, as necessary, via a coating. One part of the identifier, such as an antenna or the like, can also be situated outside, in particular in the area of the particular wall. Likewise, one part of the component can form an antenna or can be incorporated into the signal transmission in another way. Therefore, a protection of the identifier is ensured, on the one hand and, on the other hand, a secure transmission is ensured.

Finally, a vehicle comprising at least one sensor device for measuring speed, according to the descriptions presented above, is also provided. The sensor device is typically for measuring the speed of a wheel of the vehicle. The presence or the correct positioning of the sensor device can therefore be ensured. In addition, it can be determined already from outside the vehicle whether sensor devices are installed and, if so, which sensor devices. A line-of sight connection to the particular identifier is therefore not required. The vehicle is designed, in particular, for carrying out one of the above-described methods. It is therefore ensured that suitable measures for reading out the identifier can be implemented.

The identifier can be disposed on the vehicle in such a way, in particular, that the identifier are suitable for coupling the signal into an on-board electrical system of the vehicle. In this case, the identifier can be coupled to at least one electrical component of the on-board electrical system by radio or electrically. In order to achieve a sufficient coupling-in by radio or via electromagnetic wave, the identifier or an antenna thereof should be situated in sufficiently close proximity to an electrical component of the on-board electrical system, for example, to a line or an antenna of the on-board electrical system. A sufficient coupling can then take place. In certain embodiments, the identifier can be read out by the on-board electronics system. It is therefore ensured that the on-board electronics system is also informed of the presence and, if applicable, measurement data of the identifier. For example, by evaluating the sufficient coupling by radio to the on-board electrical system, it can be ensured that a correct positioning of the identifier has taken place.

### BRIEF DESCRIPTION OF THE DRAWING

The invention is described in greater detail below with reference to the accompanying figures, in which:

FIG. 1 shows a sensor device according to the invention for measuring the speed of a wheel of a vehicle.

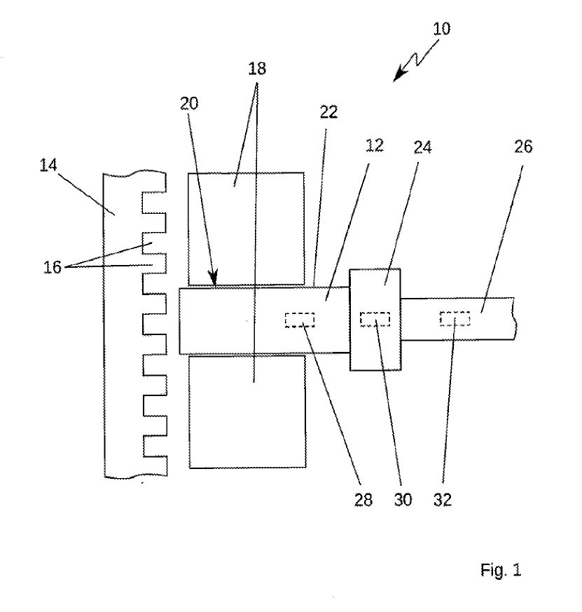

### DETAILED DESCRIPTION

Referring to the Figure, wherein like numerals indicate corresponding parts, a device for determining the speed of a wheel (not shown) is generally shown at 10. The device 10 contains a sensor device 12 for the actual speed measurement. The speed of the assigned wheel of the vehicle is therefore measured. The sensor device 12 is therefore also referred to as a wheel speed sensor.

For example, the relative movement of a toothed bar 14, which is moved along with a non-illustrated wheel, can be determined via an optical or inductive measurement. During a movement of the toothed bar 14, regular projections and recesses 16 on and in the toothed bar 14 generate a periodic signal of pulses in the sensor device 12. This pulse signal is proportional to the movement of the toothed bar 14 and, therefore, to the speed of the associated wheel.

In order to ensure a stable mounting, the sensor device 12 is usually installed in a bearing element 18 of the associated vehicle. For this purpose, the bearing element 18 defines a through hole 20 in this case. The sensor device 12 comprises a housing 22 which is essentially cylindrical in this case. The housing 22 of the sensor device 12 is then inserted into the through hole 20 defined by the bearing element 18. In addition, the housing 22 is fastened in the through hole 20, in order to prevent an unwanted movement.

The sensor device 12, including the housing 22, is surrounded nearly completely by the bearing element 18 in this case. A short subregion of the housing 22, including the plug-in connection 24, is situated outside only on the right end region in the Figure. This plug-in connection 24 connects the sensor device 12, on the one hand, and, on the other hand, a cable section or a corresponding cable 26. The cable 26 is used for connecting the sensor device 12 to an on-board electronics system of the vehicle. The actual measured values from the sensor device 12 for the speed of the assigned wheel are transmitted via this cable 26. In addition, the cable 26 is used for supplying current to the sensor device 12.

As is apparent from the Figure, features applied to the surface for the purpose of identification or for the identification of the sensor device 12 are usually difficult to read out or cannot be read out at all, due to the typical installation in a corresponding holding element 18. Thus, the solution according to the invention is shown here with three alternative positions 28, 30 and 32 for corresponding identifiers. The identifiers 28, 30, 32 can be designed practically identically in all cases. This identifier can be read out by radio, for example an RFID chip.

In the first case, the identifier 28 is mounted directly on the housing 22 of the sensor device 12. A recess in the housing or an indentation can be provided for this purpose, for example. Material can then be applied for covering, in order to protect the identifier 28. Due to the readout by radio, an identification of the sensor device 12 via the identifier 28 can also take place in the installed state.

In the case of the position of the identifier 30 in the region of the plug-in connection 24, there can be two alternatives. On the one hand, the identifier 30 can be assigned to the part of the plug-in connection 24 that is fixedly connected to the sensor device 12. In this case, it is advantageous that the identifier 30 is situated further outside the holding element 18 in the region of the plug-in connection 24. Plug-in connections 24 are often manufactured from plastic or a similar material, thereby ensuring better transparency for electromagnetic waves than is the case with metal components. For the case in which the identifier 30 is situated on sides of the part of the plug-in connection 24 that are detachable from the sensor device 12, an unambiguous identification of the sensor device 12 is still possible. The installation of the sensor device 12 is already established during the first installation within the scope of the production of the vehicle. An unambiguous identification of the sensor device 12 is therefore possible. For the rest, the plug-in connections 24 are typically usable only for exactly one sensor type, thereby ensuring that mix-ups with other sensor types usually cannot occur.

Finally, the third position of the identifier 32 can be assumed in the region of the cable 26. This offers advantages similar to those related to the positioning in the region of the plug-in connection 24. Since the cable 26 is fixedly connected to the cable-side part of the plug-in connection 24, the assignment of the sensor device 12 to the corresponding plug-in connection 24 and to the cable section 26 is also already established during the manufacturing of the vehicle. An unambiguous identification of the sensor device 12 can therefore take place.

When the identifier 30 or 32 is situated in the region of the plug-in connection 24 or the cable 26, a further advantage arises. Due to the proximity of the electrical lines to the on-board electronics system of the vehicle, a radio signal from the identifier 30 or 32 can be coupled into the electrical network of the on-board electronics system. The on-board electronics system is therefore enabled to read out the radio signal from the identifier 30 or 32. An identification of the sensor device 12 is therefore possible both via a suitable external reading device and by the on-board electronics system thereof.

A method according to the invention is described in greater detail in the following, by way of example:

A suitable reading device, which is not shown here, is brought proximate to the identifier 28, 30 or 32. The reader can emit electrical energy by radio. By way of the identifier 28, 30 or 32 suitably receiving and temporarily storing the energy, the identifier is enabled to emit a radio signal itself. RFID chips usually do not have a separate energy source. The identifier 28, 30 or 32 comprises a suitable antenna, which is not shown here, for receiving the electrical energy. The radio signal of the identifier 28, 30 or 32 is then used for transmitting data, in particular identification data. The emission usually takes place via the same antenna that is used for receiving energy.

The emitted radio signal is received, in turn, by the reading device. Given that the radio signal contains corresponding identification data, in particular a unique code number or the like, an identification of the sensor device 12 can take place. If necessary, a match with a database or the like must be carried out, in order to obtain a production date, a production site, a test result, or the like.

In addition to the transmission of pure identification data, the identifier 28, 30 or 32 can also transmit additional data, for example, measurement data. For this purpose, a corresponding coupling to suitable measurement elements must take place, for example, to the sensor device 12. In particular, a measured speed can therefore be linked to the corresponding identification data.

What is claimed is:

1. A method for identifying a sensor device for measuring the speed of a wheel of a vehicle, wherein assigned to the sensor device is an identifier which can be contactlessly read out, the method comprising reading out by radio the identifier of the sensor device.

2. The method as claimed in claim 1, wherein an electrical and/or magnetic signal for identification is transmitted by the identifier.

3. The method as claimed in claim 2, wherein data for identification are wirelessly transmitted with the signal.

4. The method as claimed in claim 1, wherein the identifier is at least partially assigned to a cable and/or a plug-in connection of the sensor device.

5. The method as claimed in claim 1, wherein at least one RFID transponder is used as the identifier.

6. The method as claimed in claim 1, wherein the identifier contains at least one microchip, wherein the microchip stores and/or transmits measurement data.

7. The method as claimed in claim 1, wherein the identifier is supplied with electrical energy from an external source.

8. The method as claimed in claim 2, wherein the signal of the identifier is coupled into an on-board electrical system of an assigned vehicle and/or the identifier is read out by the on-board electronics system.

9. A sensor device for measuring the speed of a wheel of a vehicle, the sensor device comprising an identifier which can be contactlessly read out, wherein the identifier can be read out by radio.

10. The sensor device as claimed in claim 9, wherein the identifier is designed as an RFID transponder, and/or the identifier comprises at least one microchip and/or at least one antenna for transmitting data.

11. The sensor device as claimed in claim 9, wherein the identifier transmits identification data.

12. The sensor device as claimed in claim 9, wherein the sensor device can be supplied with electrical energy from an external source.

13. The sensor device as claimed in claim 12, further comprising an assigned housing and/or an assigned plug-in connection and/or an assigned cable section, to which the identifier can be fastened and/or at least partially integrated.

14. A vehicle comprising at least one sensor device for measuring speed, the sensor device being the sensor device of claim 9.

15. The vehicle as claimed in claim 14, wherein a signal from the identifier can be coupled into an on-board electrical system by radio, wherein the identifier can be read out by an on-board electronics system connected to the on-board electrical system.

16. The method as claimed in claim 1, wherein the identifier is supplied with electrical energy by radio via an antenna.

17. The sensor device as claimed in claim 9 wherein the identifier can store and/or transmit measurement data in addition to the identification data.

18. The sensor device as claimed in claim 9, wherein the sensor device can be supplied with electrical energy by radio via an antenna.
